(19) United States
(12) Patent Application Publication
(10) Pub. No.: US 2008/0238378 A1
(43) Pub. Date: Oct. 2, 2008

(54) Voltage regulator

(76) Inventors: Alexander Uan-Zo-li, Hillsboro, OR (US); Jae-Hong Hahn, Beaverton, OR (US)

Correspondence Address: CAVEN & AGHEVLI;c/o INTELLEVATE, LLC, P.O. BOX 52050, MINNEAPOLIS, MN, 55402, US

(21) Appl. No.: 11/731,789

(22) Filed: Mar. 30, 2007

(51) Int. Cl. G05F 1/46

(52) U.S. Cl. 323/249

(57) ABSTRACT

In some embodiments, a voltage regulator assembly comprises a first voltage regulator circuit selectively coupled to a first input voltage and comprising a first inductor, a second regulator circuit selectively coupled to the first input voltage and comprising a second inductor to inductively couple the second regulator circuit to the first voltage regulator circuit, a bypass switch coupled to the second regulator circuit, and a controller coupled to the bypass switch comprising logic to activate the bypass switch when a load on the voltage regulator assembly falls below a threshold. Other embodiments may be described.

### BACKGROUND

The subject matter described herein relates generally to the field of electronic devices and more particularly to voltage regulators.

Power supplies generate power and maintain a relatively constant voltage and current for circuits of an electronic system. Power supplies generally convert an alternating current (AC) input voltage into a regulated direct current (DC) output voltage. In instances where the power supply input voltage is a DC voltage, a DC-DC converter such as a linear or a switching voltage regulator may be used to couple the power supply to components of an electronic device.

Some voltage regulators for DC-DC power supplies may include two or more interleaved DC-DC converters (also called phases) operating in parallel. One or more of the phases may be disabled when the power supply load is low in order to increase the efficiency of the voltage regulator. In some circumstances, an inductive coupling between the DC-DC converters may cause the current to flow through a disabled DC-DC converter, which reduces the efficiency of the voltage regulator.

### DESCRIPTION OF THE DRAWINGS

The detailed description is described with reference to the accompanying figures.

FIG. 1 is a schematic illustration of a voltage regulator assembly in accordance with some embodiments.

FIG. 2 is a schematic circuit diagram of a voltage regulator in accordance with some embodiments.

FIG. 3 is a flowchart illustrating aspects of the operation of the voltage regulator assembly depicted in FIG. 1, in accordance with some embodiments.

FIG. 4 is a schematic illustration of architecture of a computer system in accordance with some embodiments.

### DETAILED DESCRIPTION

Described herein are exemplary systems and methods for voltage regulators which may be used in, e.g., computing devices. In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

FIG. 1 is a schematic illustration of a voltage regulator assembly 100 in accordance with some embodiments. Referring to FIG. 1, a power supply voltage V_{IN} at a first voltage (e.g., 12V) is coupled to a power bus 105. A voltage regulator 115 is coupled to the first input voltage via a bus 105. Voltage regulator produces an output voltage on bus 120. In some embodiments, voltage regular produces an output voltage of 5V.

Voltage regulator assembly 100 further includes a voltage regulator controller 110 that includes logic to regulate operations of voltage regulator 115. In some embodiments, voltage controller 110 may be embodied as a programmable controller such as, e.g., a processor, a field programmable gate array (FPGA), or the like. In other embodiments, voltage regulator controller may be reduced to hardwired logic circuitry such as, e.g., a component of an application specific integrated circuit (ASIC).

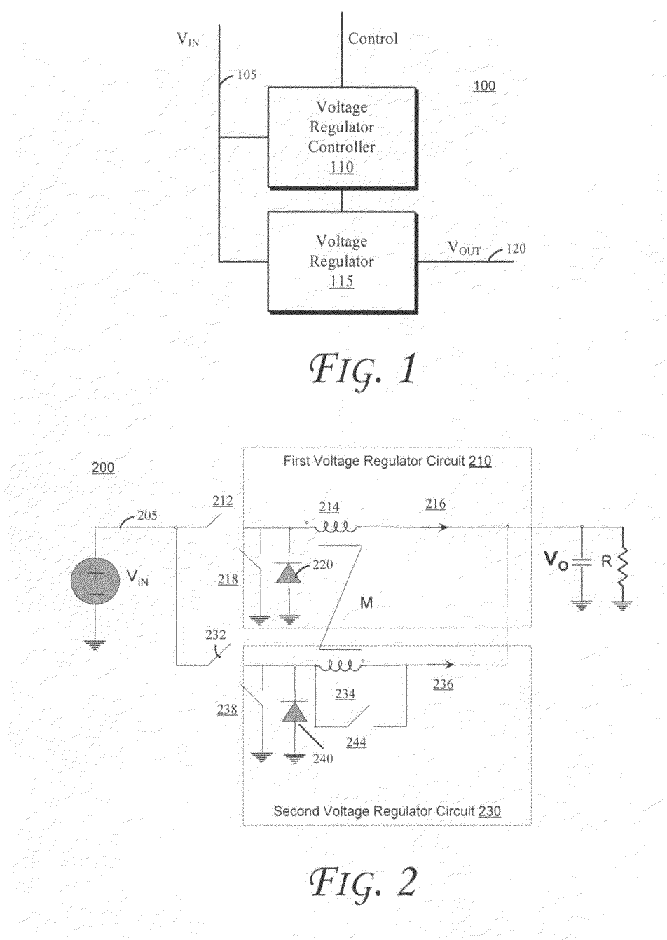

FIG. 2 is a schematic circuit diagram of a voltage regulator in accordance with some embodiments. For example, the voltage regulator 200 depicted in FIG. 2 may correspond to the voltage regulator 115 depicted in FIG. 1.

Referring to FIG. 2, voltage regulator 200 includes a power bus 205 to receive an input voltage. Voltage regulator 200 further includes a first voltage regulator circuit 210 which may be coupled to the input voltage by a switch 212 and a second voltage regulator circuit 230 which may be coupled to the input voltage by a switch 232.

First voltage regulator circuit 210 comprises an inductor 214, a switch 218, and a diode 220 or equivalent, which may be embodied as a Schottky diode. Similarly, second voltage regulator circuit 230 comprises an inductor 234, a switch 238 to connect the inductor 234 to the ground, and a diode 240, which may be embodied as a Schottky diode. A bypass switch 244 is coupled to the second regulator circuit on each side of the inductor 234.

Among other advantages, interleaving (i.e., paralleling) voltage regulator circuits 210, 230 permits lowering the ripple at the output voltage and input current.

In operation, the output voltage of such voltage regulator 200 is regulated by varying the duration of time when the switches 212 and 232 are closed.

When the voltage regulator assembly 200 is operated with a relatively light electrical load, one of the voltage regulator circuits 210, 230 may be disabled and disconnected from the power source. This saves switching losses in the voltage regulator circuit, thereby increasing the overall efficiency. However, the inductive coupling between the circuits 210, 230 does not allow a completely independent operation of the phases. For example, when the second voltage regulator circuit 230 is disconnected from the input power source and the switch 212 is turned on, the inductive coupling between the inductors 214 and 234 induces a current flow through the voltage regulator circuit 230. If the bottom switch 238 is not turned on, the current will flow through the diode 240 and cause conduction losses.

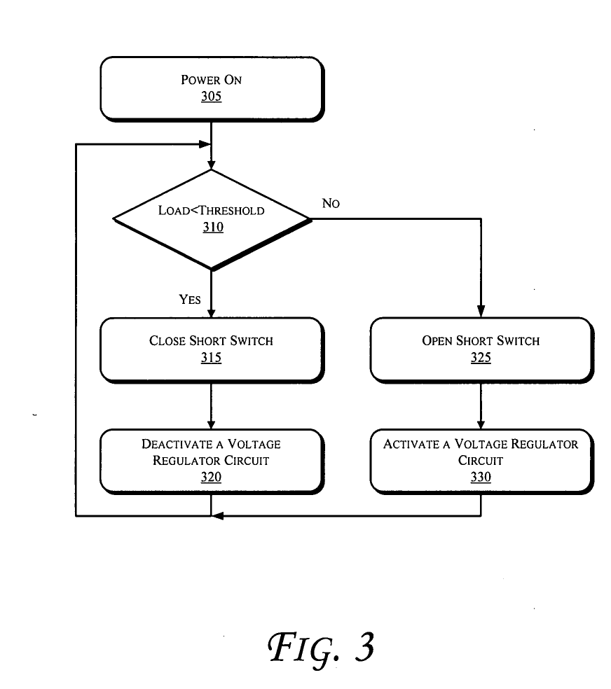

To resolve this issue, the voltage controller 110 comprises logic to operate the bypass switch 244 in a manner that short-circuits the inductor 234 when the second voltage regulator circuit 230 is in an idle phase. Operation of voltage regulator assembly 100 will be explained with referenced to FIGS. 1-3. FIG. 3 is a flowchart illustrating aspects of the operation of the voltage regulator assembly depicted in FIG. 1, in accordance with some embodiments.

Referring to FIG. 3, at operation 305 the voltage regulator assembly 100 is powered on, e.g., by applying an input voltage on bus 105 and enabling the controller 110. If, at operation 310, the load on voltage regulator assembly is less than a threshold, the control passes to operation 315 and the switch 244 is closed, which shorts out the inductor 244. Control then passes to operation 320 and the voltage regulator circuit 230 is deactivated, e.g., by disconnecting switch 232. This permits the voltage regulator circuit 210 to operate independently, i.e., without inductively coupling to voltage regulator circuit 230.

By contrast, if at operation 310 the load is not less than a threshold, then control passes to operation 325 and switch 244 is opened, which permits the circuits 210 and 230 to be inductively coupled. At operation 330 the voltage regulation circuit 230 is activated, and the switch 232 conduction is modulated.

Operations 310-330 may be repeated indefinitely in controller 110, such that controller 110 monitors the load on voltage regulation assembly 100 and operates the circuit in accord with the load.

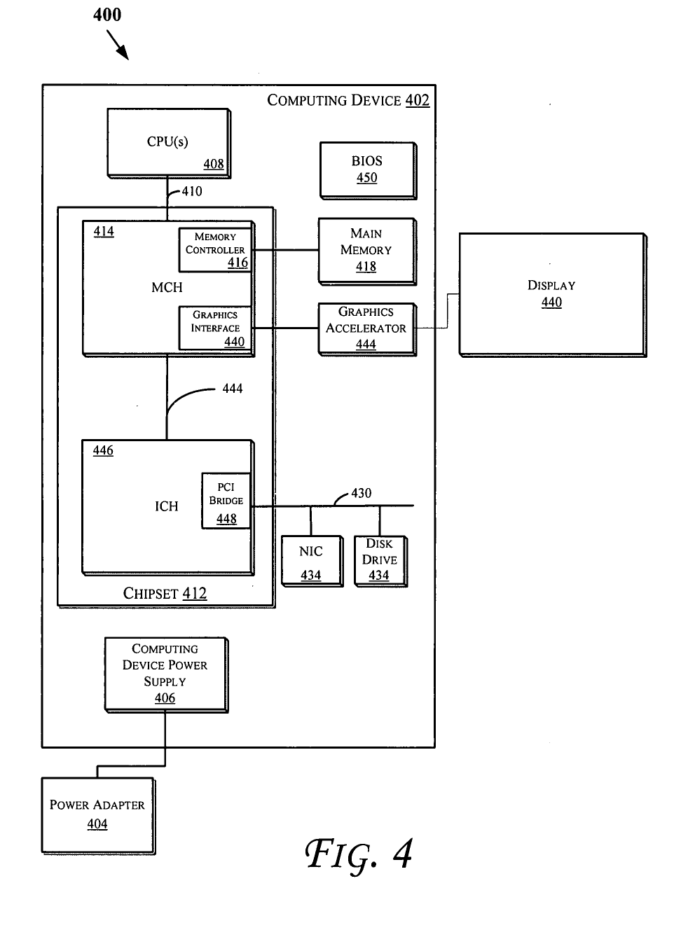

FIG. 4 is a schematic illustration of architecture of a computer system which may include a voltage regulator assembly 100 in accordance with some embodiments. Computer system 400 includes a computing device 402 and a power adapter 404 (e.g., to supply electrical power to the computing device 402). The computing device 402 may be any suitable computing device such as a laptop (or notebook) computer, a personal digital assistant, a desktop computing device (e.g., a workstation or a desktop computer), a rack-mounted computing device, and the like.

Electrical power may be provided to various components of the computing device 402 (e.g., through a computing device power supply 406) from one or more of the following sources: one or more battery packs, an alternating current (AC) outlet (e.g., through a transformer and/or adaptor such as a power adapter 404), automotive power supplies, airplane power supplies, and the like. In one embodiment, the power adapter 404 may transform the power supply source output (e.g., the AC outlet voltage of about 110VAC to 240VAC) to a direct current (DC) voltage ranging between about 7VDC to 12.6VDC. Accordingly, the power adapter 404 may be an AC/DC adapter.

The computing device 402 may also include one or more central processing unit(s) (CPUs) 408 coupled to the bus 410. In one embodiment, the CPU 408 may be one or more processors in the Pentium® family of processors including the Pentium® II processor family, Pentium® III processors, Pentium® IV processors available from Intel® Corporation of Santa Clara, Calif. Alternatively, other CPUs may be used, such as Intel's Itanium®, XEON™, and Celeron® processors. Also, one or more processors from other manufactures may be utilized. Moreover, the processors may have a single or multi core design.

A chipset 412 may be coupled to the bus 410. The chipset 412 may include a memory control hub (MCH) 414. The MCH 414 may include a memory controller 416 that is coupled to a main system memory 418. The main system memory 418 stores data and sequences of instructions that are executed by the CPU 408, or any other device included in the system 400. In some embodiments, the main system memory 418 includes random access memory (RAM); however, the main system memory 418 may be implemented using other memory types such as dynamic RAM (DRAM), synchronous DRAM (SDRAM), and the like. Additional devices may also be coupled to the bus 410, such as multiple CPUs and/or multiple system memories.

In some embodiments, main memory 418 may include a one or more flash memory devices. For example, main memory 418 may include either NAND or NOR flash memory devices, which may provide hundreds of megabytes, or even many gigabytes of storage capacity.

The MCH 414 may also include a graphics interface 420 coupled to a graphics accelerator 422. In one embodiment, the graphics interface 420 is coupled to the graphics accelerator 422 via an accelerated graphics port (AGP). In an embodiment, a display (such as a flat panel display) 440 may be coupled to the graphics interface 420 through, for example, a signal converter that translates a digital representation of an image stored in a storage device such as video memory or system memory into display signals that are interpreted and displayed by the display. The display 440 signals produced by the display device may pass through various control devices before being interpreted by and subsequently displayed on the display.

A hub interface 424 couples the MCH 414 to an input/output control hub (ICH) 426. The ICH 426 provides an interface to input/output (I/O) devices coupled to the computer system 400. The ICH 426 may be coupled to a peripheral component interconnect (PCI) bus. Hence, the ICH 426 includes a PCI bridge 428 that provides an interface to a PCI bus 430. The PCI bridge 428 provides a data path between the CPU 408 and peripheral devices. Additionally, other types of I/O interconnect topologies may be utilized such as the PCI Express™ architecture, available through Intel® Corporation of Santa Clara, Calif.

The PCI bus 430 may be coupled to a network interface card (NIC) 432 and one or more disk drive(s) 434. Other devices may be coupled to the PCI bus 430. In addition, the CPU 408 and the MCH 414 may be combined to form a single chip. Furthermore, the graphics accelerator 422 may be included within the MCH 414 in other embodiments.

Additionally, other peripherals coupled to the ICH 426 may include, in various embodiments, integrated drive electronics (IDE) or small computer system interface (SCSI) hard drive(s), universal serial bus (USB) port(s), a keyboard, a mouse, parallel port(s), serial port(s), floppy disk drive(s), digital output support (e.g., digital video interface (DVI)), and the like.

System 400 may further include a basic input/output system (BIOS) 450 to manage, among other things, the boot-up operations of computing system 400. BIOS 450 may be embodied as logic instructions encoded on a memory module such as, e.g., a flash memory module.

In the description and claims, the terms coupled and, along with their derivatives, may be used. In particular embodiments, connected may be used to indicate that two or more elements are in direct physical or electrical contact with each other. Coupled may mean that two or more elements are in direct physical, electrical or magnetic contact. However, coupled may also mean that two or more elements may not be in direct contact with each other, but yet may still cooperate or interact with each other.

Reference in the specification to “one embodiment” or “an embodiment” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A voltage regulator assembly, comprising:
a first voltage regulator circuit selectively coupled to a first input voltage and comprising a first inductor;
a second regulator circuit selectively coupled to the first input voltage and comprising a second inductor which is magnetically coupled with the inductor in the first voltage regulator;
a bypass switch coupled to the second regulator circuit; and
a controller coupled to the bypass switch comprising logic to activate the bypass switch when a load on the voltage regulator assembly falls below a threshold.

2. The voltage regulator assembly of claim 1, wherein the controller further comprises logic to deactivate the bypass switch when a load on the voltage regulator assembly exceeds a threshold.

3. The voltage regulator assembly of claim 1, further comprising a switch to selectively couple the first regulator circuit to a power source.

4. The voltage regulator assembly of claim 1, further comprising a switch to selectively couple the second regulator circuit to a power source.

5. The voltage regulator assembly of claim 1, wherein the controller further comprises logic to decouple the first regulator circuit from the power source when a load on the voltage regulator assembly falls below a threshold.

6. The voltage regulator assembly of claim 5, wherein the controller further comprises logic to decouple the second regulator circuit from the power source when a load on the voltage regulator assembly falls below a threshold.

7. The voltage regulator assembly of claim 1, wherein:
the first voltage regulator circuit receives input having a first phase; and
the second voltage regulator circuit receives input having a second phase, different from the first phase.

8. A system, comprising:
a display;
at least one integrated circuit; and
a voltage regulator assembly, comprising:
a first voltage regulator circuit selectively coupled to a first input voltage and comprising a first inductor; and
a second regulator circuit selectively coupled to the first input voltage and comprising a second inductor to inductively couple the second regulator circuit to the first voltage regulator circuit;
a bypass switch in the second regulator circuit; and
a controller coupled to the bypass switch comprising logic to activate the bypass switch when a load on the voltage regulator assembly falls below a threshold.

9. The system of claim 8, wherein the controller further comprises logic to deactivate the bypass switch when a load on the voltage regulator assembly exceeds a threshold.

10. The system of claim 8, further comprising a switch to selectively couple the first regulator circuit to a power source.

11. The system of claim 8, further comprising a switch to selectively couple the second regulator circuit to a power source.

12. The system of claim 11, wherein the controller further comprises logic to decouple the second regulator circuit from the power source when a load on the voltage regulator assembly falls below a threshold.

13. The system of claim 11, wherein the controller further comprises logic to decouple the second regulator circuit from the power source when a load on the voltage regulator assembly falls below a threshold.

14. The system of claim 8, wherein:
the first voltage regulator circuit receives input having a first phase; and
the second voltage regulator circuit receives input having a second phase, different from the first phase.
